(19) United States
(12) Patent Application Publication
(10) Pub. No.: US 2024/0164444 A1
(43) Pub. Date: May 23, 2024

(54) VAPORIZATION DEVICE

(71) Applicant: Shenzhen Relx Technology Co., Ltd., Shenzhen City, Guangdong Province (CN)

(72) Inventors: Shengyang XU, Shenzhen City, Guangdong Province (CN); Yangyun JIN, Shenzhen City, Guangdong Province (CN); Hui WANG, Shenzhen City, Guangdong Province (CN)

(21) Appl. No.: 17/434,997

(22) PCT Filed: Jan. 8, 2020
(86) PCT No.: PCT/CN2020/070859

§ 371 Date: Aug. 30, 2021

(51) Int. Cl. A24F 40/40; A24F 40/10; A24F 40/51; A24F 40/90; H02J 7/00

(52) U.S. Cl. CPC A24F 40/40; A24F 40/10; A24F 40/51; A24F 40/90; H02J 7/0042

(57) ABSTRACT

The present application relates to a vaporization device. The provided vaporization device includes an e-liquid storage component and a body. The e-liquid storage component includes an electrical coupling point. The body is electrically coupled to the e-liquid storage component, and includes a body shell, a power supply component holder, a power supply component, a charging conductive component and a magnetically conductive component. The body shell includes a cavity. The power supply component holder is disposed in the cavity, and includes a first end and a second end opposite to each other. The power supply component is disposed on the power supply component holder. The charging conductive component is disposed at the second end of the power supply component holder. The magnetically conductive component is disposed at the second end of the power supply component holder.

### CROSS REFERENCE TO RELATED APPLICATIONS

This application is a national stage application filed under 35 U.S.C. § 371, of International Patent Application No. PCT/CN2020/070859, filed on Jan. 8, 2020, which is incorporated by reference herein its entirety.

### BACKGROUND OF THE INVENTION

### 1. Field of the Invention

The present invention generally relates to an electronic device, and more particularly to a vaporization device for providing an inhalable aerosol.

### 2. Description of the Related Art

With the increasingly strict regulations and restrictions on tobacco products in various regions and governments around the world, people's demands for tobacco substitutes also continue to grow. An electronic cigarette device may be a tobacco substitute, which uses an electronic aerosol generation device or an electronic vaporization device to vaporize a vaporizable material (for example, e-liquid) to generate an aerosol for inhalation by a user, thereby achieving a sensory experience of simulated smoking. Compared to traditional tobacco products, the electronic cigarette device as the substitute can effectively reduce harmful substances generated by combustion, thereby reducing harmful side effects of smoking.

However, the electronic cigarette device in repetitive use often has some limitations, including the need to replace or fill e-liquids, complicated operations, e-liquid leakage, scorching, shortage of battery life, and high prices, which inevitably results in a poor user experience. Therefore, it is necessary to further develop and improve the electronic cigarette device.

Therefore, a vaporization device which can resolve the above problems is provided in the present disclosure.

### SUMMARY OF THE INVENTION

A vaporization device is provided. The vaporization device includes an e-liquid storage component and a body. The e-liquid storage component includes an electrical coupling point. The body is electrically coupled to the e-liquid storage component, and includes a body shell, a power supply component holder, a power supply component, a charging conductive component and a in magnetically conductive component. The body shell includes a cavity. The power supply component holder is disposed in the cavity, and includes a first end and a second end opposite to each other. The power supply component is disposed on the power supply component holder. The charging conductive component is disposed at the second end of the power supply component holder. The magnetically conductive component is disposed at the second end of the power supply component holder.

A vaporization device is provided, including an e-liquid storage component and a body. The e-liquid storage component includes a first electrical coupling point and a second electrical coupling point. The body is electrically coupled to the first electrical coupling point and the second electrical coupling point, and the body includes a body shell, a power supply component holder, an electrically conductive component, two charging conductive components and a port. The body shell includes a cavity. The power supply component holder is disposed in the cavity, and includes a first end and a second end opposite to each other. The electrically conductive component is disposed at the first end of the power supply component holder. The electrically conductive component is configured to be electrically coupled to the first electrical coupling point. The two charging conductive components are disposed at the second end of the power supply component holder. The port is located at the second end, and is located between the two charging conductive components.

### BRIEF DESCRIPTION OF THE DRAWINGS

The aspects of the present invention will become more comprehensible from the following detailed description made with reference to the accompanying drawings. It should be noted that, various features may not be drawn to scale, and the sizes of the various features may be increased or reduced arbitrarily for the purpose of clear description.

FIG. 1A is an exemplary top view of a vaporization device according to some embodiments of the present application.

FIG. 1B is an exemplary bottom view of a vaporization device according to some embodiments of the present application.

FIG. 1C is an exemplary front view of a vaporization device according to some embodiments of the present application.

FIG. 1D is an exemplary side view of a vaporization device according to some embodiments of the present application.

FIG. 1E is an exemplary back view of a vaporization device according to some embodiments of the present application.

FIG. 2A is a cross-sectional schematic view of a front surface of a vaporization device according to some embodiments of the present invention.

FIG. 2B is a cross-sectional schematic view of a side surface of a vaporization device according to some embodiments of the present invention.

FIG. 3A and FIG. 3B are three-dimensional schematic exploded views of an e-liquid storage component according to some embodiments of the present invention.

FIG. 3C is a schematic exploded view of a front surface of an e-liquid storage component according to some embodiments of the present invention.

FIG. 3D is a three-dimensional cross-sectional schematic view of a side surface of an e-liquid storage component according to some embodiments of the present invention.

FIG. 4A is a schematic diagram of a front surface of an e-liquid storage component according to some embodiments of the present application.

FIG. 4B is a schematic diagram of a side surface of an e-liquid storage component according to some embodiments of the present application.

FIG. 4C is a schematic diagram of a top surface of an e-liquid storage component according to some embodiments of the present application.

FIG. 4D is a schematic diagram of a bottom surface of an e-liquid storage component according to some embodiments of the present application.

FIG. 4E is a cross-sectional schematic view of a front surface of an e-liquid storage component according to some embodiments of the present application.

FIG. 4F is a cross-sectional schematic view of a side surface of an e-liquid storage component according to some embodiments of the present application.

FIG. 4G is a schematic exploded view of a cross section of a front surface of an e-liquid storage component according to some embodiments of the present application.

FIG. 5A is a schematic exploded view of a body according to some embodiments of the present invention.

FIG. 5B is a cross-sectional schematic view of a front surface of a body according to some embodiments of the present application.

FIG. 5C is a schematic diagram of a side surface of a body according to some embodiments of the present application.

FIG. 5D is a schematic diagram of a side surface of a body according to some embodiments of the present application.

FIG. 6 is a cross-sectional schematic view of a side surface in which a vaporization device according to some embodiments of the present application is disposed in an accommodation device.

The drawings and detailed descriptions use the same reference numerals to indicate same or similar elements. Features of the present invention will be more apparent from the detailed descriptions made with reference to the accompanying drawings.

### PREFERRED EMBODIMENT OF THE PRESENT INVENTION

The following disclosed content provides many different embodiments or examples of different features used to implement the provided subject matters. The following describes particular examples of components and deployments. Certainly, there are merely examples and are not intended to be limitative. In the present invention, in the following descriptions, reference formed by the first feature above or on the second feature may include an embodiment formed by direct contact between the first feature and the second feature, and may further include an embodiment in which an additional feature may be formed between the first feature and the second feature to enable the first feature and the second feature to be not in direct contact. In addition, in the present invention, reference numerals and/or letters may be repeated in examples. This repetition is for the purpose of simplification and clarity, and does not indicate a relationship between the described various embodiments and/or configurations.

The embodiments of the present invention are described in detail below. However, it should be understood that, the present invention provides many applicable concepts that can be implemented in various particular cases. The described particular embodiments are only illustrative and do not limit the scope of the present invention.

As used herein, the term “aerosol for inhalation by a user” may include, but is not limited to, aerosols, suspended liquids, low temperature vapors, and volatile gases.

Embodiments of the present application provide a vaporization device. The vaporization device may include a disposable electronic cigarette. The disposable electronic cigarette is an electronic cigarette device that does not repeatedly replace, inject or modify various components, for example, a battery or a vaporizable material (e-liquid) contained therein. The vaporization device may vaporize a vaporizable material through a heating device to generate an aerosol for inhalation by a user. The vaporization device of the present invention may simplify the operation of the user and improve the user experience.

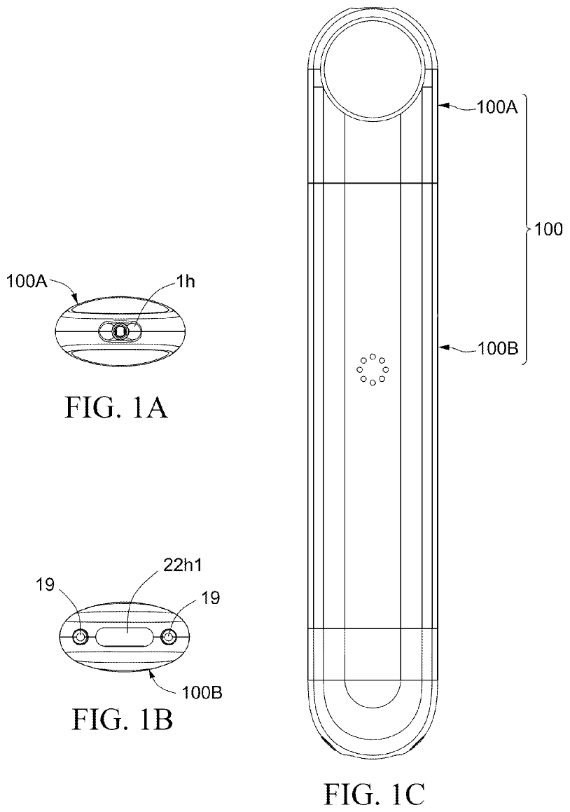

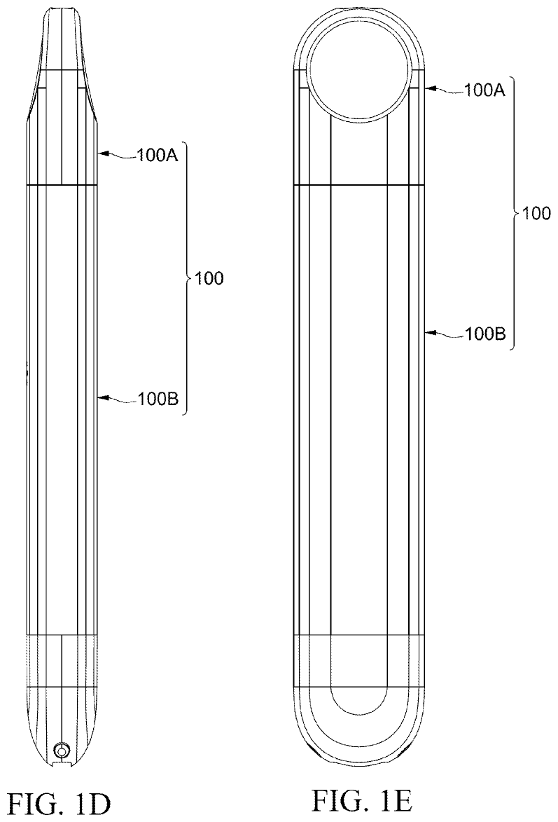

FIG. 1A, FIG. 1B, FIG. 1C, FIG. 1D and FIG. 1E are exemplary views of a top surface, a bottom surface, a front surface, a side surface and a back surface of a vaporization device according to some embodiments of the present application.

A vaporization device 100 may include an e-liquid storage component (cartridge) 100A and a body 100B. In some embodiments, the e-liquid storage component 100A and the body 100B may be designed as a unity. In some embodiments, the e-liquid storage component 100A and the body 100B may be designed as two separate components. In some embodiments, the e-liquid storage component 100A may be designed to be removably combined with the body 100B. In some embodiments, when the e-liquid storage component 100A is combined with the body 100B, the e-liquid storage component 100A may be designed to be partly received in the body 100B. In some embodiments, the e-liquid storage component 100A may be referred to as a cartridge, and the body 100B may be referred to as a main body or a battery component.

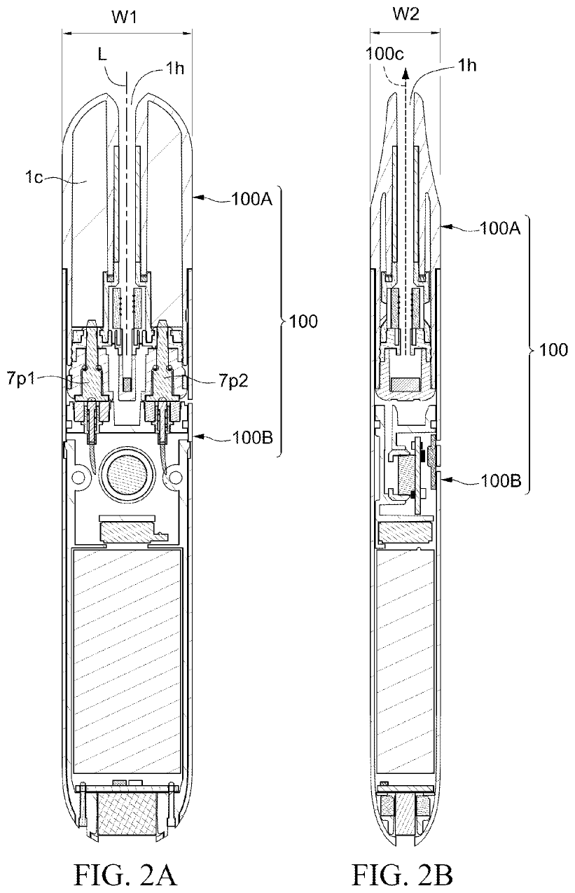

FIG. 2A and FIG. 2B are cross-sectional schematic views of a front surface and a side surface of a vaporization device according to some embodiments of the present invention.

A vaporization device 100 includes a central axis L, and the central axis L substantially runs through an aerosol channel 100c of the e-liquid storage component 100A and a mouthpiece hole 1h of a mouthpiece cap 1. In other words, an axis of the aerosol channel 100c is substantially the same as part of the central axis L. In some embodiments, the vaporization device 100 may be in a long flat shape. A maximum value of first width W1 of the front surface shown in FIG. 2A is greater than a maximum value of second width W2 of the side surface shown in FIG. 2B.

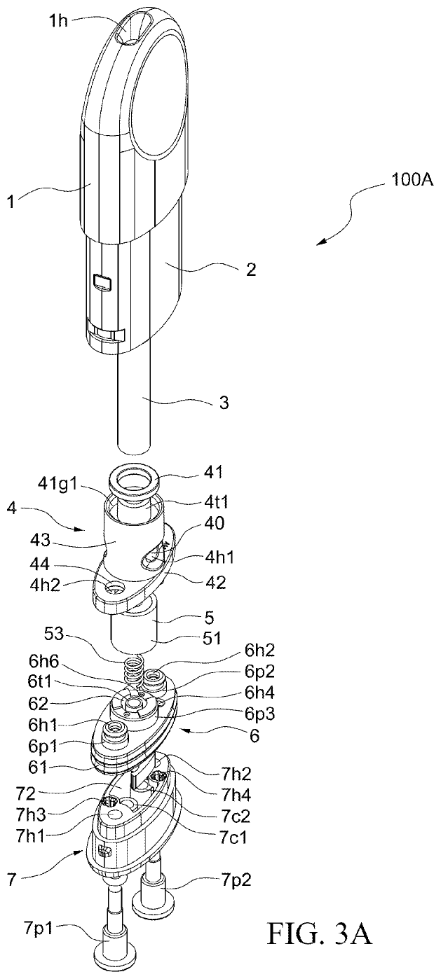

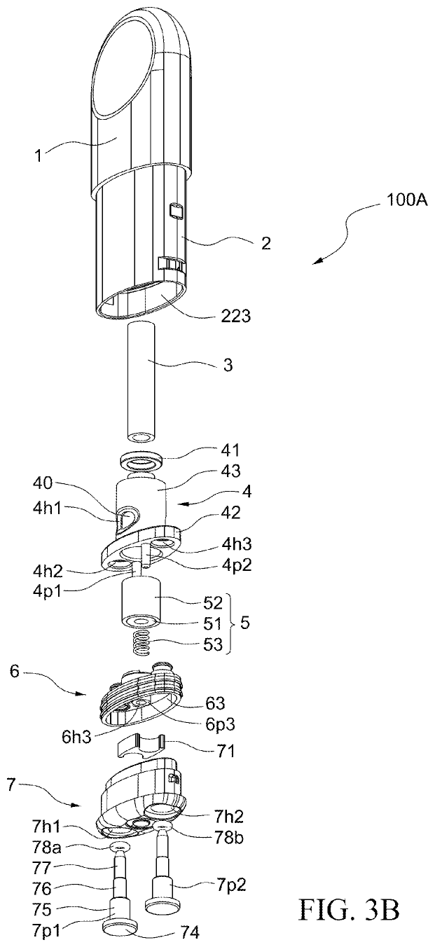

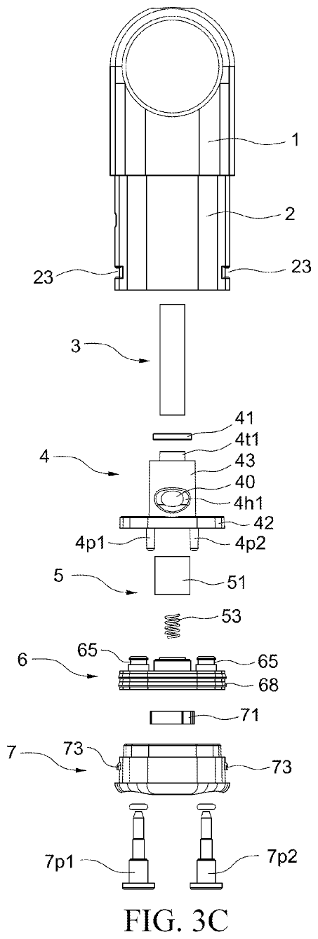

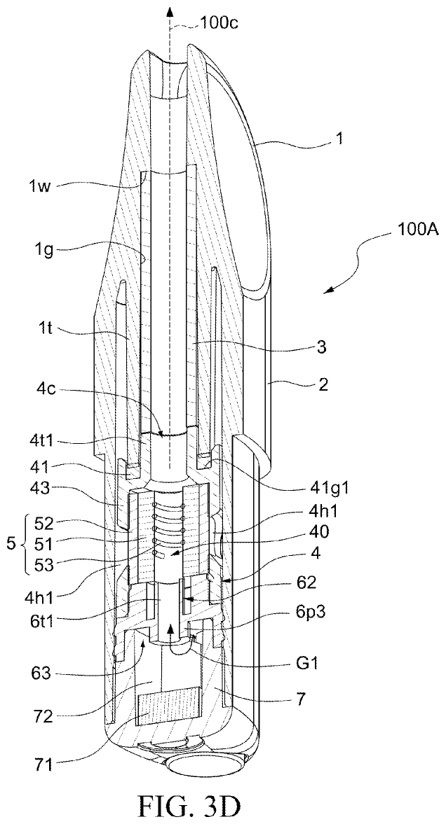

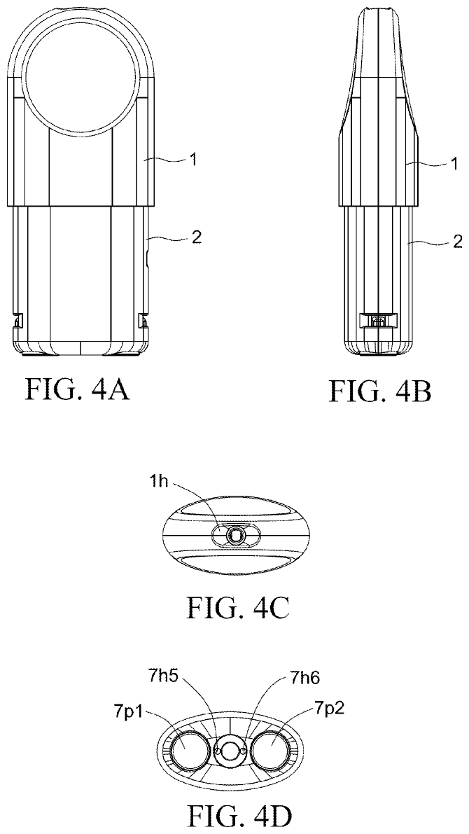

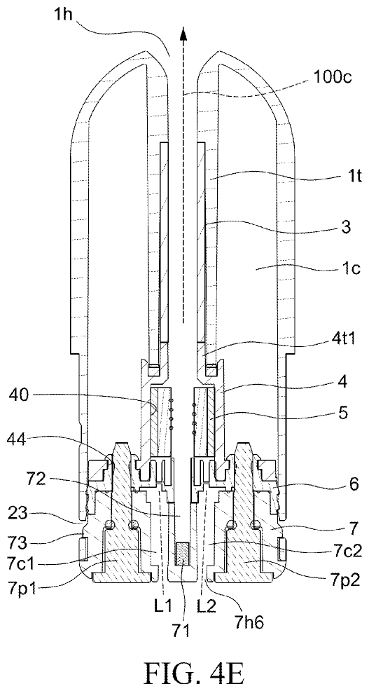

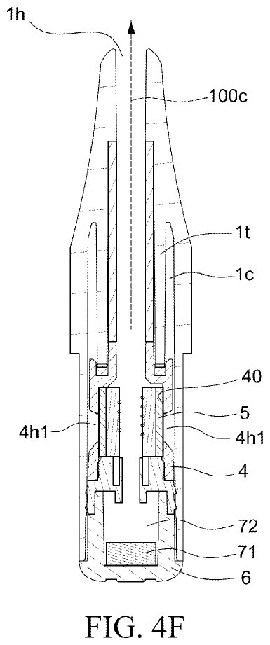

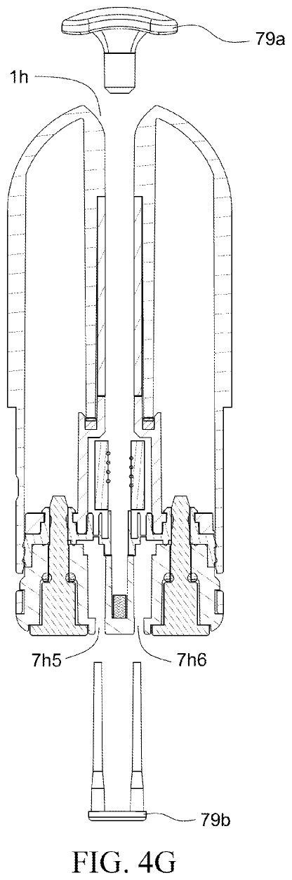

FIG. 3A, FIG. 3B, and FIG. 3C are three-dimensional schematic exploded views of an e-liquid storage component according to some embodiments of the present application. FIG. 3D is a three-dimensional cross-sectional schematic view of a side surface of an e-liquid storage component according to some embodiments of the present invention. FIG. 4A, FIG. 4B, FIG. 4C and FIG. 4D are exemplary schematic diagrams of a front surface, a side surface, a top surface, and a bottom surface of an e-liquid storage component according to some embodiments of the present application. FIG. 4E and FIG. 4F are exemplary cross-sectional schematic views of a front surface and a side surface of the e-liquid storage component in FIG. 4A and FIG. 4B.

As shown in FIG. 3A to FIG. 3D, an e-liquid storage component 100A may include a mouthpiece cap 1, an e-liquid storage component shell 2, a first liquid absorbing component 3, a heating component top cap 4, a heating component 5, a heating component base 6, an e-liquid cup base 7, and columnar electrically conductive structures 7p1 and 7p2.

In some embodiments, the mouthpiece cap 1 and the e-liquid storage component shell 2 may be two separate components. In some embodiments, the mouthpiece cap 1 and the e-liquid storage component shell 2 may be integrally formed, to form an e-liquid storage shell together. The mouthpiece cap 1 has a mouthpiece hole 1h. The mouthpiece hole 1h forms part of the aerosol channel 100c. Aerosol generated by the vaporization device 100 may be inhaled by the user through the mouthpiece hole 1h. As shown in FIG. 4E and FIG. 4F, the mouthpiece cap 1 includes therein a mouthpiece tube 1t, and the mouthpiece tube 1t extends inside the e-liquid storage component shell 2 from the mouthpiece hole 1h. As shown in the FIG. 4E, a width of the aerosol channel 100c near the mouthpiece hole 1h may be gradually extended outwards along the mouthpiece hole 1h, which helps emission of smoke. As shown in FIG. 4F, the width of the aerosol channel 100c may be substantially the same.

In addition, there is a storage compartment 1c between a shell of the mouthpiece cap 1 and the mouthpiece tube 1t. The e-liquid storage component shell 2 has an opening 223 (shown in FIG. 3B). The storage compartment 1c and the mouthpiece tube 1t are exposed to the outside through the opening 223.

As shown in FIG. 3D, in some embodiments, the first liquid absorbing component 3 is disposed on an inner wall surface of the mouthpiece tube 1t. In some embodiments, the inner wall surface of the mouthpiece tube 1t has an annular groove 1g, which is formed outwards along a radial direction of the inner wall surface of the mouthpiece tube 1t. The first liquid absorbing component 3 is in a shape of a long tube, and is disposed in the annular groove 1g of the inner wall surface of the mouthpiece tube 1t. One end of the first liquid absorbing component 3 abuts against a side wall 1w of the annular groove 1g, and the other end of the first liquid absorbing component 3 abuts against a convex connection tube 4t1 of the heating component top cap 4. In some embodiments, when the first liquid absorbing component 3 is disposed in the annular groove 1g of the inner wall surface of the mouthpiece tube 1t, an inner diameter of the first liquid absorbing component 3 is substantially the same as an inner diameter of the inner wall surface (that is, an inner wall surface without the annular groove) of the mouthpiece tube 1t. In this way, because the first liquid absorbing component 3 is disposed in the annular groove 1g, and one end, which is adjacent to the mouthpiece tube 1t, of the first liquid absorbing component 3 abuts against the side wall 1w of the annular groove 1g, the user cannot remove the first liquid absorbing component 3 from the mouthpiece hole 1h.

In some embodiments, the first liquid absorbing component 3 may be in a shape of a long cylinder. A material of the first liquid absorbing component 3 may include a cotton core. In some embodiments, a material of the first liquid absorbing component 3 may include nonwoven fabric. In some embodiments, a is material of the first liquid absorbing component 3 may include macromolecular polymer. In some embodiments, the first liquid absorbing component 3 may include a combination of a cotton core, nonwoven fabric and macromolecular polymer.

As shown in FIG. 3A to FIG. 3D, a sealing component 41 may be disposed in an annular stop groove 41g1 outside the connection tube 4t1 of the heating component top cap 4. As shown in FIG. 3A and FIG. 3D, when the mouthpiece cap 1 and the e-liquid storage component shell 2 are mounted on the heating component top cap 4, a free end of the mouthpiece tube 1t abuts against the sealing component 41, and is engaged in the annular stop groove 41g1. That is, the sealing component 41 is engaged between the free end of the mouthpiece tube 1t and a bottom of the stop groove 41g1. In some embodiments, the sealing component 41 may be annular. In some embodiments, the sealing component 41 may be in another shape. The sealing component 41 may be flexible. The sealing component 41 may be extensible. In some embodiments, a material of the sealing component 41 may include silica gel. In some embodiments, hardness of the sealing component 41 may be between 20 and 40. In some embodiments, hardness of the sealing component 41 may be between 40 and 60. In some embodiments, hardness of the sealing component 41 may be between 60 and 75. A hardness unit used herein is Shore Hardness A (HA).

In some embodiments, the heating component top cap 4 and the heating component base 6 may form a “heating component accommodation shell” together, which is configured to accommodate the heating component.

As shown in FIG. 3A to FIG. 3C, the heating component top cap 4 mainly includes a bottom 42, a main body 43, a connection tube 4t1 and positioning columns 4p1 and 4p2. The main body 43 is located between the bottom 42 and the connection tube 4t1. The positioning column 4p1 and the positioning column 4p2 extend from the bottom 42 toward the heating component base 6. The heating component top cap 4 includes a through flow channel 4c (as shown in FIG. 3D), and the through flow channel 4c runs through the bottom 42, a vaporization chamber 40 of the main body 43, and the connection tube 4t1. In some embodiments, the positioning columns 4p1 and 4p2 may include a pillar shape or a cone shape.

As shown in FIG. 3A to FIG. 3D, two opposite sides of the heating component top cap 4 have liquid inlet holes 4h1, respectively formed on two opposite surfaces, for example, the front surface and the back surface (as shown in FIG. 3D and FIG. 4F), of the vaporization device 100, and the liquid inlet holes 4h1 run through the main body 43. In this way, the through flow channel 4c may communicate with the outside of the heating component top cap 4 through the liquid inlet holes 4h1. In some embodiments, the liquid inlet holes 4h1 may be located on two opposite sides, which are relatively flat, of the vaporization device 100. In this way, volatile substances do not heavily enter the vaporization chamber 40. In addition, when the mouthpiece cap 1 and the e-liquid storage component shell 2 are mounted on the heating component top cap 4, the inside of the mouthpiece cap 1 and the e-liquid storage component shell 2 and an outside top of the heating component top cap 4 form a storage compartment 1c. The storage compartment 1c is configured to store a liquid such as an e-liquid. The mouthpiece cap 1, the e-liquid storage component shell 2 and the heating component top cap 4 define the storage compartment 1c. The vaporizable material may be stored in the storage compartment 1c. The vaporizable liquid may be stored in the storage compartment 1c. The vaporizable material may be a liquid. The vaporizable material may be a solution. In subsequent paragraphs of the present application, the vaporizable material may be referred to as e-liquid. The e-liquid is edible. In addition, the e-liquid may flow to the inside of the heating component top cap 4 through the liquid inlet hole 4h1 of the heating component top cap 4.

As shown in FIG. 3A and FIG. 3B, there are first electrically conductive channels 4h2 and 4h3 on two sides of the bottom 42, and the first electrically conductive channels run through the bottom 42. As shown in FIG. 3A and FIG. 4E, there are first engaging structures 44 on inner wall surfaces, which are adjacent to the main body 43 and that are located on the bottom 42, of the first electrically conductive channels 4h2 and 4h3. In some embodiments, the first engaging structure 44 is an annular bump.

The heating component top cap 4 may include a plastic material. In some embodiments, the heating component top cap 4 may include materials such as polypropylene (PP), low density polyethylene (LDPE), and high-density polyethylene (HDPE). In some embodiments, a material of the heating component top cap 4 may include silica gel.

The heating component top cap 4 and the sealing component 41 may be formed by using a same material. The heating component top cap 4 and the sealing component 41 may be formed by using different materials. The heating component top cap 4 and the sealing component 41 may include different materials. In some embodiments, hardness of the heating component top cap 4 may be greater than hardness of the sealing component 41. In some embodiments, the hardness of the heating component top cap 4 may be between 65 and 75. In some embodiments, the hardness of the heating component top cap 4 may be between 75 and 85. In some embodiments, the hardness of the heating component top cap 4 may be between 85 and 90.

As shown in FIG. 3D, in some embodiments, in the through flow channel 4c, the through flow channel 4c has a groove located in the main body 43, to form the vaporization chamber 40. The heating component 5 is disposed in the vaporization chamber 40.

As shown in FIG. 3A to FIG. 3D, the heating component 5 may include a hollow tube 51, a liquid absorbing sleeve 52 and a heating core 53. The liquid absorbing sleeve 52 surrounds an outer wall of the hollow tube 51, and the heating core 53 is disposed on an inner wall surface of the hollow tube 51. In some embodiments, the heating core 53 is welded to the inner wall surface of the hollow tube 51 in a spiral manner. An inner channel of the hollow tube 51, the inner diameter of the first liquid absorbing component 3 and the inner diameter of the inner wall surface of the mouthpiece tube 1t may be substantially the same. In some embodiments, the inner channel of the hollow tube 51, the inner diameter of the first liquid absorbing component 3 and the inner diameter of the inner wall surface of the mouthpiece tube 1t may be different.

The heating core 53 may further be buried in the hollow tube 51, and may extend to the outside of the hollow tube 51, to be exposed on an outer wall surface of the hollow tube 51. In addition, an opening, which is located at the bottom 42, of the through flow channel 4c is greater than an outer diameter of the heating component 5, and an opening, which is located at the connection tube 4t1, of the through flow channel 4c is less than the outer diameter of the heating component 5. Therefore, when the heating component 5 is mounted in the through flow channel 4c, the heating component 5 may only enter from the bottom 42, and cannot enter the through flow channel 4c from the connection tube 4t1. Such configuration may improve the stable arrangement for the heating component 5.

In some embodiments, the material of the hollow tube 51 may include ceramics, and the hollow tube 51 is configured to adsorb e-liquid. In some embodiments, the material of the hollow tube 51 may include silicon oxide. In some embodiments, the material of the hollow tube 51 may include aluminium oxide. In some embodiments, the material of the hollow tube 51 may include zirconium oxide. In some embodiments, the material of the hollow tube 51 may include a porous material, for example, one or more of cotton, a carbon fiber material, a silicone material, and a ceramic material. A material of the liquid is absorbing sleeve 52 is a polymer material. For example, the material of the liquid absorbing sleeve 52 may be polypropylene (PP) or polyethylene (PE).

The liquid absorbing sleeve 52 is disposed between the liquid inlet hole 4h1 and the hollow tube 51. The liquid absorbing sleeve 52 may adsorb e-liquid. The liquid absorbing sleeve 52 may prevent e-liquid in the storage compartment 1c from directly contacting the hollow tube 51. The liquid absorbing sleeve 52 may adjust an amount of e-liquid adsorbed by the hollow tube 51. The liquid absorbing sleeve 52 may reduce a probability of leak for what e-liquid cannot be completely adsorbed by the hollow tube 51.

Referring to FIG. 3A, the heating component base 6 includes a base body 61, electrically conductive columns 6p1 and 6p2, a guide column 6p3, and a flow guide tube 6t1. The electrically conductive columns 6p1 and 6p2, the guide column 6p3, and the flow guide tube 6t1 are disposed on the base body 61, and extend toward the heating component top cap 4.

A groove in the heating component top cap 4 and the heating component base 6 define the vaporization chamber. The vaporization chamber may be a cavity between the heating component top cap 4 and the heating component base 6. In other words, the heating component 5 is buried in the vaporization chamber.

The flow guide tube 6t1 is located in the guide column 6p3, and an annular groove 62 is formed between the flow guide tube 6t1 and the guide column 6p3. The electrically conductive columns 6p1 and 6p2 are located on two opposite sides of the guide column 6p3, and second electrically conductive channels 6h1 and 6h2 in the electrically conductive columns 6p1 and 6p2 respectively correspond to the first electrically conductive channels 4h2 and 4h3 of the heating component top cap 4. The base body 61 further includes positioning holes 6h3 and 6h4, and the positioning columns 4p1 and 4p2 may run through the positioning holes 6h3 and 6h4, so that the heating component top cap 4 and the heating component base 6 position each other. The base body 61 further includes an accommodation groove 63. The accommodation groove 63 faces the e-liquid cup base 7, and is configured to accommodate part of the e-liquid cup base 7. The guide column 6p3 further extends in the accommodation groove 63. As shown in FIG. 3A, a top surface of the guide column 6p3 may include a step. The step is configured to support the heating component 5. When a condensate with a volatile material flows down the condensate flows to an annular groove 62 corresponding to the inner wall surface of the heating component 5, to prevent the condensate from flowing to the aerosol channel 100c or the e-liquid cup base 7.

As shown in FIG. 3C, in some embodiments, the electrically conductive columns 6p1 and 6p2 includes second engaging structures 65. As shown in FIG. 4E, the second engaging structures 65 are configured to respectively engage the first engaging structures 44 of the heating component top cap 4. In some embodiments, the second engaging structures 65 are annular grooves, and are configured to correspond to the annular bumps of the first engaging structures 44. As shown in FIG. 3A, in some embodiments, the heating component base 6 further includes through holes 6h5 and 6h6. The through holes 6h5 and 6h6 may run through the base body 61 and the guide column 6p3.

In some embodiments, the outside of the base body 61 of the heating component base 6 further includes an annular flange 68. The annular flange 68 may be engaged to an inner wall of the e-liquid storage component shell 2, to improve stable disposing of the heating component base 6 and the e-liquid storage component shell 2.

As shown in FIG. 3A and FIG. 3B, the e-liquid cup base 7 includes a flow guide groove 72, third electrically conductive channels 7h1 and 7h2, positioning grooves 7h3 and 7h4, air inlet holes 7h5 and 7h6, and hollow flow guide columns 7c1 and 7c2. The third electrically conductive channels 7h1 and 7h2 are respectively located on two sides of the flow guide groove 72. The third electrically conductive channels 7h1 and 7h2 run through the e-liquid cup base 7, and the third electrically conductive channels 7h1 and 7h2 correspond to the second electrically conductive channels 6h1 and 6h2 of the heating component base 6. The positioning grooves 7h3 and 7h4 are located on two sides of the flow guide groove 72, and respectively correspond to the positioning holes 6h3 and 6h4 of the base body 61. In this way, as shown in FIG. 4E, when the heating component top cap 4, the heating component base 6 and the e-liquid cup base 7 are mounted together, the positioning columns 4p1 and 4p2 may run through the positioning holes 6h3 and 6h4 and the positioning grooves 7h3 and 7h4, so that the heating component top cap 4, the heating component base 6 and the e-liquid cup base 7 position each other.

In some embodiments, an opening of the flow guide groove 72 faces the accommodation groove 63 of the heating component base 6. As shown in FIG. 3A to FIG. 3D, the hollow flow guide columns 7c1 and 7c2 are located in the flow guide groove 72, one ends of the hollow flow guide columns 7c1 and 7c2 respectively communicate with the air inlet holes 7h5 and 7h6, and another ends of the hollow flow guide columns 7c1 and 7c2 are located in the flow guide groove 72 and face the heating component base 6. In some embodiments, the aerosol channel 100c is a channel through which an air flow between the flow guide groove 72 and the mouthpiece hole 1h runs. Two opposite sides of the guide column 6p3 of the heating component base 6 respectively abut against corresponding end edges of the hollow flow guide columns 7c1 and 7c2. In some embodiments, the e-liquid cup base 7 includes a second liquid absorbing component 71 disposed on a bottom of the flow guide groove 72. The second liquid absorbing component 71 is configured to absorb the vaporizable liquid, for example, e-liquid, from the aerosol channel 100c and the heating component 5. The second liquid absorbing component 71 and the flow guide groove 72 may be H-shaped, to avoid the hollow flow guide columns 7c1 and 7c2. As shown is in FIG. 4E, the air inlet holes 7h5 and 7h6 are between the columnar electrically conductive structures 7p1 and 7p2, however, the air inlet holes 7h5 and 7h6 are not in the center, that is, do not run through the central axis L. In addition, extension directions L1 and L2 of the hollow flow guide columns 7c1 and 7c2 and an extension direction (the aerosol channel 100c) of the first liquid absorbing component do not intersect with each other. In some embodiments, the extension directions L1 and L2 of the hollow flow guide columns 7c1 and 7c2 and the extension direction (that is, an extension direction of the aerosol channel 100c) of the first liquid absorbing component are parallel, but do not intersect with each other. As shown in FIG. 3D, FIG. 4E, FIG. 4F and FIG. 4G, when the air inlet holes 7h5 and 7h6 of the hollow flow guide columns 7c1 and 7c2 enter the e-liquid cup base 7, the guide column 6p3 changes an original straight forward moving direction of an air flow G1 (as shown in FIG. 3D), so that the air flow G1 is guided into the flow guide groove 72 again. Then the air flow enters the vaporization chamber 40 in the heating component top cap 4 along an axis direction and through a through hole in the guide column 6p3 of the heating component base 6. Through such non-straight-line air flow guide manner, it is effectively prevented that a vaporizable material and a condensate thereof flows out from the air inlet holes 7h5 and 7h6 of the e-liquid cup base 7 of the e-liquid storage component 100A.

As shown in FIG. 3C, in some embodiments, the e-liquid storage component shell 2 has an engaging hole 23, and the e-liquid cup base 7 includes an engaging block 73. During assembly, the engaging hole 23 and the engaging block 73 may be correspondingly engaged with each other, to improve engaging fixing of the e-liquid storage component shell 2 and the e-liquid cup base 7.

As shown in FIG. 2A, the columnar electrically conductive structures 7p1 and 7p2 may be used as electrical coupling points with the body 100B. That is, the columnar electrically conductive structures 7p1 and 7p2 are configured to receive a power supply from the body 100B. As shown in FIG. 3A to FIG. 3B, when the heating component top cap 4, the heating component base 6 and the e-liquid cup base 7 are mounted together, the columnar electrically conductive structures 7p1 and 7p2 may respectively extend through the third electrically conductive channels 7h1 and 7h2 of the e-liquid cup base 7, the second electrically conductive channels 6h1 and 6h2 of the heating component base 6 and the first electrically conductive channels 4h2 and 4h3 of the heating component top cap 4, so that, as shown in FIG. 4E, the columnar electrically conductive structures 7p1 and 7p2 enter the storage compartment 1c of the mouthpiece cap 1.

Taking the columnar electrically conductive structure 7p1 shown in FIG. 3B as an example, in some embodiments, the columnar electrically conductive structure 7p1 includes a base 74, a first connection section 75, a second connection section 76 and a third connection section 77 that are connected to each other and are gradually smaller. The base 74 is exposed outside the e-liquid storage component 100A, and may be in a shape of a flat circle. When the columnar electrically conductive structure 7p1 is inserted into the e-liquid cup base 7, the heating component base 6, and the heating component top cap 4, a top of the third connection section 77 is located in the storage compartment 1c. In some embodiments, the e-liquid storage component 100A may further include annular pads 78a and 78b, which are disposed between the first connection section 75 and the second connection section 76, and abut against a wall surface of the third electrically conductive channels 7h1 and 7h2 of the e-liquid cup base 7. The annular pads 78a and 78b are configured to prevent a liquid from flowing out from the third electrically conductive channels 7h1 and 7h2. The annular pads 78a and 78b are O-rings, and are elastic. A material of the annular pads 78a and 78b may be silica gel.

In some embodiments, when the columnar electrically conductive structures 7p1 and 7p2 are not mounted, the third electrically conductive channels 7h1 and 7h2 of the e-liquid cup base 7, the second electrically conductive channels 6h1 and 6h2 of the heating component base 6 and the first electrically conductive channels 4h2 and 4h3 of the heating component top cap 4 may be used as a liquid injection channel. As shown in FIG. 4E, when an assembler finishes injecting a liquid into the storage compartment 1c, the assembler may mechanically couple the columnar electrically conductive structures 7p1 and 7p2 and the annular pads 78a and 78b to the third electrically conductive channels 7h1 and 7h2 of the e-liquid cup base 7, the second electrically conductive channels 6h1 and 6h2 of the heating component base 6 and the first electrically conductive channels 4h2 and 4h3 of the heating component top cap 4, to seal the liquid injection channel.

In some embodiments, a material of the columnar electrically conductive structures 7p1 and 7p2 may be metal such as ferrum, which is configured to conduct electricity. The base 74 of the columnar electrically conductive structures 7p1 and 7p2 may be coated with a metallic protection layer, and a material thereof may be, for example, aurum. The metallic protection layer may protect the base 74 and improve an appearance. In some embodiments, the heating component 5 includes an electrically conductive line (not shown). One end of the electrically conductive line is connected to the columnar electrically conductive structures 7p1 and 7p2, extends from the third electrically conductive channels 7h1 and 7h2 to the flow guide groove 72 of the e-liquid cup base 7 and the accommodation groove 63 of the heating component base 6, and runs through the through holes 6h5 and 6h6 to be connected to a central part of the heating component 5, that is, the heating core 53 located on the outer wall surface of the hollow tube 51 in some embodiments. Through the foregoing described configuration manner, the columnar electrically conductive structures 7p1 and 7p2 are electrically coupled to the heating core 53 of the heating component 5. In another embodiment, electrical coupling between the columnar electrically conductive structures 7p1 and 7p2 and the heating component 5 may be implemented through different paths. By supplying power to the columnar electrically conductive structures 7p1 and 7p2, the vaporization device 100 may increase a temperature of the heating core 53 of the heating component 5.

In some embodiments, the heating core 53 and the electrically conductive line may include a metallic material. In some embodiments, the heating core 53 and the electrically conductive line may include silver. In some embodiments, the heating core 53 and the electrically conductive line may include platinum. In some embodiments, the heating core 53 and the electrically conductive line may include palladium. In some embodiments, the heating core 53 and the electrically conductive line may include nickel. In some embodiments, the heating core 53 and the electrically conductive line may include a nickel alloy material.

As shown in FIG. 4G, in some embodiments, the vaporization device 100 further includes a first protection plug 79a and a second protection plug 79b. The first protection plug 79a is detachably disposed, and extends into the mouthpiece hole 1h. The second protection plug 79b is detachably disposed, and extends into the air inlet holes 7h5 and 7h6 of the e-liquid cup base 7. In this way, the first protection plug 79a and the second protection plug 79b may protect the inside of the mouthpiece hole 1h and the air inlet holes 7h5 and 7h6, and prevent a foreign matter from entering. When the user starts to use the vaporization device 100, the first protection plug 79a and the second protection plug 79b need to be removed first, to use the vaporization device 100.

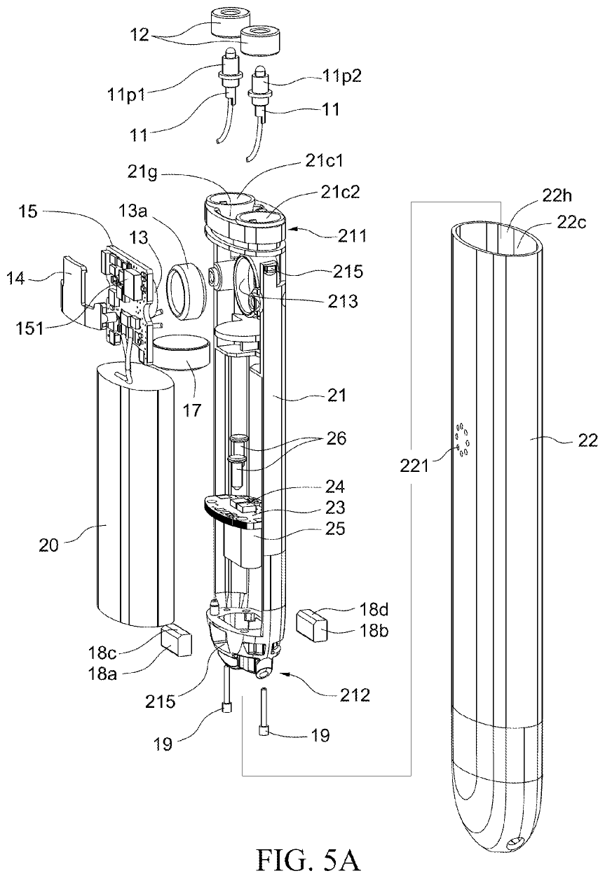

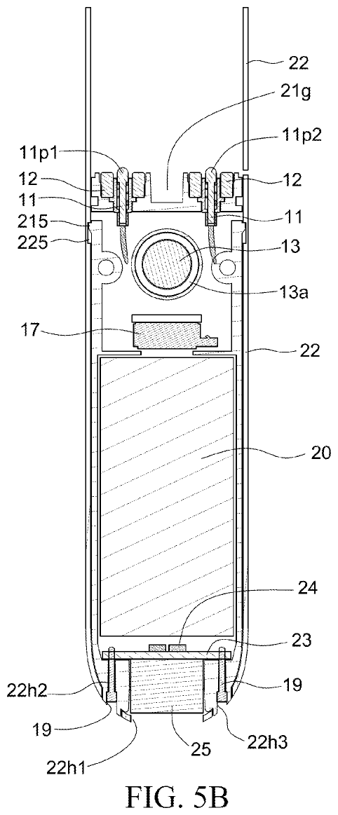

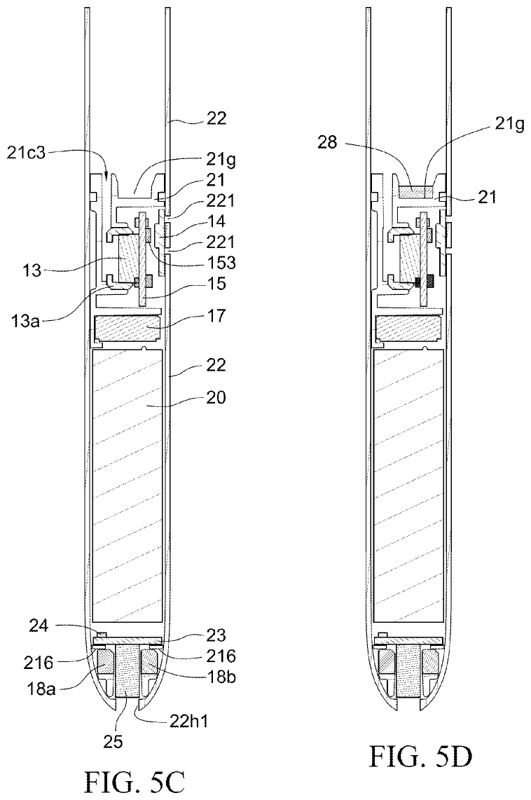

FIG. 5A is a schematic exploded view of a body according to some embodiments of the present invention. FIG. 5B and FIG. 5C are respectively schematic diagrams of a front surface and a side surface of a body according to some embodiments of the present application.

In some embodiments, a body 100B may provide a power supply to the e-liquid storage component 100A. The body 100B may include an electrically conductive component 11, a magnetic component 12, a sensor 13, a sealing kit 13a, a light guide holder 14, a main circuit board 15, a vibrator 17, magnetically conductive components 18a and 18b, a charging conductive component 19, a power supply component 20, a power supply component holder 21, a body shell 22, a charging circuit board 23, an adjustment circuit 24 and a port 25.

The body shell 22 has an opening 22h and a cavity 22c. The power supply component holder 21 is disposed in the cavity 22c of the body shell 22 through the opening 22h of the body shell 22. As shown in FIG. 1C and FIG. 5C, a surface of the body shell 22 has a light transmitting component 221. A plurality of light transmitting components 221 may surround and form a certain shape or image, for example, a circle. The light transmitting component 221 may be a through hole. A material of the body shell 22 may be metal, to improve the entire strength of the vaporization device 100. For example, the material of the body shell 22 may be aluminum, to reduce the entire weight.

The power supply component holder 21 has a first end 211 and a second end 212 opposite to each other. In the first end 212 (or may be referred to as a top), the power supply component holder 21 has electrically conductive grooves 21c1 and 21c2, and a groove portion 21g. The groove portion 21g is formed between the electrically conductive grooves 21c1 and 21c2, and faces the air inlet holes 7h5 and 7h6. The electrically conductive grooves 21c1 and 21c2 correspond to the columnar electrically conductive structures 7p1 and 7p2, and the third electrically conductive channels 7h1 and 7h2. The groove portion 21g corresponds to the air inlet holes 7h5 and 7h6.

FIG. 5D is a schematic diagram of a side surface of a body according to some embodiments of the present application. As shown in FIG. 5D, in some embodiments, the body 100B may include a liquid absorbing component 28 such as a liquid absorbing cotton, which is disposed in the groove portion 21g. The liquid absorbing component 28 is configured to adsorb a condensed liquid, for example, e-liquid, falling from the inner wall surfaces of the air inlet holes 7h5 and 7h6. In some embodiments, the liquid absorbing component 28 and the groove portion 21g may be H-shaped, to avoid the electrically conductive grooves 21c1 and 21c2. In addition, as shown in FIG. 5C, the power supply component holder 21 further includes an air flow channel 21c3 running through an upper part of the power supply component holder 21. The air flow channel 21c3 is located adjacent to the groove portion 21g, while there is an interval between the air flow channel 21c3 and the groove portion 21g.

As shown in FIG. 5B, an inner wall surface of the body shell 22 includes an engaging portion 225, and the first end 211 of the power supply component holder 21 may include an elastic engaging component 215. The engaging portion 225 of the body shell 22 may be mechanically coupled to the elastic engaging component 215. In some embodiments, the engaging portion 225 may be a groove body extending toward the inside of the body shell 22, and the elastic engaging component 215 may be a cantilever. The cantilever may be engaged in the engaging portion 225. Such configured may improve an engaging effect of the power supply component holder 21 and the body shell 22, and prevent an incorrect relative displacement between the power supply component holder 21 and the body shell 22.

In some embodiments, a quantity of the electrically conductive components 11 is two. The two electrically conductive components 11 are respectively disposed in the two electrically conductive grooves 21c1 and 21c2, and the two electrically conductive components 11 may respectively runs through the electrically conductive grooves 21c1 and 21c2, to be electrically coupled to the main circuit board 15. The two electrically conductive components 11 respectively include electrically conductive pins 11p1 and 11p2. The electrically conductive pins 11p1 and 11p2 may be respectively electrically coupled (connected) to the heating component 5 through the columnar electrically conductive structures 7p1 and 7p2.

In some embodiments, the magnetic component 12 may be separately disposed on the electrically conductive pins 11p1 and 11p2 of the electrically conductive components 11. The magnetic component 12 may be a permanent magnet. In some embodiments, the magnetic component 12 may be an electromagnet. In some embodiments, the magnetic component 12 itself has magnetic properties. In some embodiments, the magnetic component 12 has magnetic properties after being energized.

The sensor 13 is disposed in a sensor installation groove 213 of the power supply component holder 21. After the e-liquid storage component 100A and the body 100B are mounted, a small slot is generated between the e-liquid storage component 100A and the body 100B, for an air flow to enter the vaporization device 100. In some embodiments, the sensor 13 may detect a generation or a change of the air flow through the air flow channel 21c3 (shown in FIG. 5C) of the power supply component holder 21. In some embodiments, the sensor 13 may detect an acoustic wave through the air flow channel 21c3. In addition, the sealing kit 13a may be disposed between the sensor 13 and the power supply component holder 21, to strengthen the stable arrangement for the sensor 13. In some embodiments, the sensor 13 may be in a shape of a flat column, and the sealing kit 13a may be in a shape of a cylinder.

The main circuit board 15 is disposed between the light guide holder 14 and the power supply component holder 21. The main circuit board 15 includes a light-emitting component 153 corresponding to (and facing) the light transmitting component 221. The light-emitting component 153 is configured to emit light to the light transmitting component 221. In some embodiments, the light guide holder 14 may be attached to the inner wall surface of the body shell 22, and seal the light transmitting component 221. The light guide holder 14 may be transparent or translucent, so that the light emitted by the light-emitting component 153 is diffused from the inside of the body shell 22 through the light transmitting component 221. In some embodiments, the light transmitting component 221 may appear in a generally rectangle shape. In some embodiments, the light transmitting component 221 may appear in a generally symmetrical shape. In some embodiments, the light transmitting component 221 may appear in a generally asymmetrical shape. The light emitted by the one or more light-emitting components 153 on the main circuit board 15 is visible through the light transmitting component 221.

The main circuit board 15 includes a controller 151. The controller 151 may be a microprocessor. The controller 151 may be a programmable integrated circuit. The controller 151 may be a programmable logic circuit. In some embodiments, after the controller 151 is manufactured, arithmetic logic in the controller 151 cannot be changed. In some embodiments, after the controller 151 is manufactured, arithmetic logic in the controller 151 can be changed programmably.

The controller 151 may be electrically connected to the sensor 13. The controller 151 may be electrically connected to the electrically conductive component 11. The controller 151 may be electrically connected to the power supply component 20. When the sensor 13 detects an airflow, the controller 151 may control the power supply component 20 to supply power to the electrically conductive component 11. When the sensor 13 detects a barometric change, the controller 151 may control the power supply component 20 to supply power to the electrically conductive component 11. When the sensor 13 detects a negative pressure, the controller 151 may control the power supply component 20 to supply power to the electrically conductive component 11. When the controller 151 determines that an air pressure that the sensor 13 detects is lower than a threshold, the controller 151 may control the power supply component 20 to supply power to the electrically conductive component 11. When the sensor 13 detects an acoustic wave, the controller 151 may control the power supply component 20 to supply power to the electrically conductive component 11. When the controller 151 determines that an amplitude of the acoustic wave that the sensor 13 detects is higher than a threshold, the controller 151 may control the power supply component 20 to supply power to the electrically conductive component 11.

The vibrator 17 may be disposed on the power supply component holder 21, and may be electrically connected to the controller 151. In some embodiments, the vibrator 17 is electrically connected to the controller 151 on the main circuit board 15 through an electrical cable.

Based on different operation states of the vaporization device 100, the controller 151 may control the vibrator 17 to produce different somatosensory effects. In some embodiments, when the user inhales for more than a specific length of time, the controller 151 may control the vibrator 17 to vibrate, so as to remind the user to stop inhaling. In some embodiments, when the user charges the atomizer device 100, the controller 151 may control the vibrator 17 to vibrate, so as to indicate that charging has started. In some embodiments, when the atomizer device 100 has been charged, the controller 151 may control the vibrator 17 to vibrate, so as to indicate that charging has been completed.

The power supply component 20 may be disposed in the power supply component holder 21. The power supply component 20 may be electrically coupled to the sensor 13, the main circuit board 15, the controller 151, the vibrator 17, the charging conductive component 19, the charging circuit board 23, the adjustment circuit 24, and the port 25 directly or indirectly. In some embodiments, the power supply component 20 is located between the main circuit board 15 and the charging circuit board 23. In other words, compared to the charging circuit board 23, the main circuit board 15 is closer to the first end 211, and compared to the main circuit board 15, the charging circuit board 23 is closer to the second end 212.

The magnetically conductive components 18a and 18b are disposed on the second end 212 (or is referred to as a bottom) of the power supply component holder 21. One ends of the magnetically conductive components 18a and 18b is are exposed through openings 22h2 and 22h3 of the body shell 22. In some embodiments, the magnetically conductive components 18a and 18b are inserted into an installation groove 216, which is located in the second end 212, of the power supply component holder 21 through a manner of interference-fitting. That is, sizes of the magnetically conductive components 18a and 18b may be somewhat greater than a size of the installation groove 216 of the power supply component holder 21. In this way, the magnetically conductive components 18a and 18b are firmly disposed on the power supply component holder 21. In some embodiments, a surface of the magnetically conductive components 18a and 18b may include adhesive sheets 18c and 18d, configured to strengthen the fixing arrangement for the magnetically conductive components 18a and 18b and the installation groove 216 of the power supply component holder 21. For example, the adhesive sheet may be a back adhesive or a double faced adhesive tape.

In some embodiments, the port 25 is disposed in a first opening 22h1 of the second end 212 of the body shell 22, and is fixed to the charging circuit board 23. The central axis L runs through the port 25 and the first opening 22h1. The port 25 may be a universal serial bus (USB) port. In some embodiments, the port 25 includes a USB Type-C port. The port 25 may further be a connection line, to charge the vaporization device 100.

In some embodiments, an outer side of the first opening 22h1 of the second end 212 of the body shell 22 is a camber surface, and an inner side of the first opening 22h1 is a planar surface. In this way, because the inner side of the first opening 22h1 is a planar surface, compared to a period design of uniform wall thickness, an component slot between the port 25 and the first opening 22h1 may be improved. That the outer side of the first opening 22h1 is a camber surface may improve a visual appearance, and is designed based on ergonomics, which helps the user to hold.

The adjustment circuit 24 is disposed on the charging circuit board 23. The charging circuit board 23 is fixed to a platform of the second end 212 of the power supply component holder 21 through a fixing component 26. The charging circuit board 23 is electrically coupled to the adjustment circuit 24 and the main circuit board 15. In some embodiments, the adjustment circuit] 24 may be a switch.

The charging conductive component 19 may run through second openings 22h2 and 22h3 of the second end 212 of the body shell 22. The charging conductive component 19 may be electrically coupled to the charging circuit board 23 and/or the main circuit board 15. As shown in FIG. 5B, the charging conductive component 19 is electrically coupled to the charging circuit board 23 directly, and an external device may charge the power supply component 20 through the charging conductive component 19. In some embodiments, the charging conductive component 19 is located on two opposite sides of the port 25. In some embodiments, the charging conductive component 19 may be a metallic probe. In some embodiments, the charging conductive component 19 may be a pogo pin (or is referred to as a pogo probe), disposed between the power supply component 20 and the body shell 22. The charging conductive component 19 may make direct contact with a surface 20S of the power supply component 20 and an inner wall of the body shell 22. An extra buffer component may be disposed between the power supply component 20 and the power supply component holder 21, even though it is not shown in the drawings.

In some embodiments, the power supply component 20 may be a battery. In some embodiments, the power supply component 20 may be a rechargeable battery. In some embodiments, the power supply component 20 may be a disposable battery.

In some embodiments, the magnetically conductive components 18a and 18b may have a same polarity (magnetic polarity) when facing the outer side of is the vaporization device 100 (for example, a direction facing the opening 22h1, or a direction away from the e-liquid storage component 100A). For example, the magnetically conductive components 18a and 18b are simultaneously the S-pole, or simultaneously the N-pole. When the magnetically conductive components 18a and 18b has a same polarity when facing the direction away from the e-liquid storage component (that is, facing the outer side of the vaporization device 100), when the vaporization device 100 needs to be connected to an external accommodation device (for example, a charging box or a charging base) with a corresponding polarity, the vaporization device 100 may be normally attached to the external device regardless of whether the vaporization device 100 is put in the external device with the front surface or the back surface, and the vaporization device 100 is normally charged through the charging conductive component 19.

In addition, in another embodiment, the magnetically conductive components 18a and 18b may have different polarities (that is, the polarities are opposite to each other) when facing a direction away from the e-liquid storage component (that is, facing the outer side of the vaporization device 100). That is, one of the magnetically conductive components 18a and 18b is the N-pole, and another one is the S-pole. When the magnetically conductive components 18a and 18b may have different polarities when facing the outer side of the vaporization device 100, when the vaporization device 100 is put into an external accommodation device in a non-corresponding direction, a magnetically conductive component in the external device may bounce the vaporization device 100, so that the user may immediately learn that the vaporization device 100 is inserted into the charging box in a wrong manner.

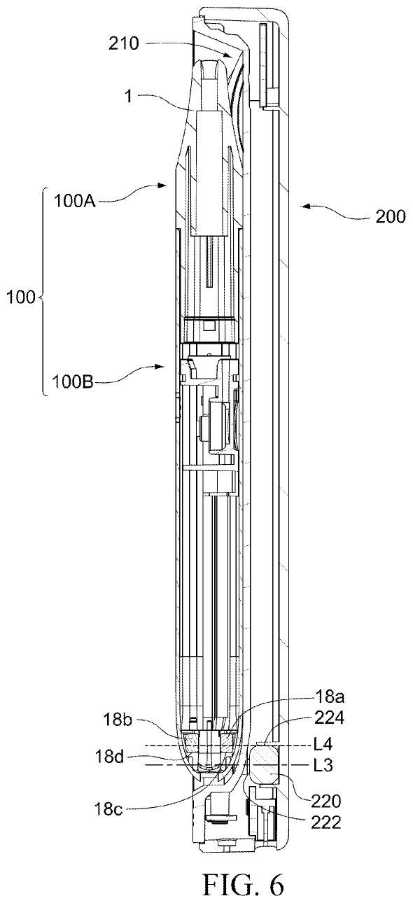

FIG. 6 is a cross sectional schematic view of a side surface in which a vaporization device 100 according to some embodiments of the present application is disposed in an accommodation device 200. As shown in FIG. 6, is the vaporization device 100 may be accommodated in an accommodation device 200. For example, the accommodation device 200 may include an accommodation groove 210, and the accommodation groove 210 may be configured to accommodate the vaporization device 100. On the other hand, in some embodiments, the accommodation device 200 may use a charging function, to charge the vaporization device 100. In some embodiments, the accommodation device 200 may include a magnetic component 220, where the magnetic component 220 is disposed under one end of the accommodation groove 210.

In some embodiments, a central axis normal L3 extended by a top surface 222 of the magnetic component 220 does not run through the magnetically conductive components 18a and 18b of the vaporization device 100, while a tangent L4 of a side edge 224 adjacent to the vaporization device 100 near the top surface 222 of the magnetic component 220 runs through the magnetically conductive components 18a and 18b corresponding to the body 100B of the vaporization device 100. That is, the magnetically conductive components 18a and 18b is closer to a central area of the accommodation device 200 compared to the magnetic component 220. For example, when the top surface 222 of the magnetic component 220 is the N-pole, an end surface 18c, which is outward the vaporization device 100 (a direction away from the e-liquid storage component 100A), of the magnetically conductive component 18a is the S-pole, and an end surface 18b, which is outward the vaporization device 100 (a direction away from the e-liquid storage component 100A) of the magnetically conductive component 18c is the N-pole. Because the top surface 222 of the magnetic component 220 and the relatively close magnetically conductive component 18a of the magnetically conductive components 18a and 18b attract each other, the vaporization device 100 may be correctly disposed in a specified position of the accommodation device 200. Because the top surface 222 of the magnetic component 220 and the relatively far magnetically conductive component 18b of the magnetically conductive components 18a and 18b repel each other, it is prevented that because of too much magnetic forces, the magnetically conductive component 18a causes an opposite side surface (that is, the end edge of the mouthpiece cap 1 of the e-liquid storage component 100A) of the vaporization device 100 to be warped or bounced. As a result, the magnetically conductive component 18b has an effect of stably disposing the vaporization device 100 in the accommodation device 200.

In some embodiments, if the charging box and the charging base corresponding to the vaporization device 100 does not have a corresponding polarity (electric polarity), the adjustment circuit 24 on the charging circuit board 23 may be configured to adjust a current from the charging conductive component 19, to complete charging. Therefore, regardless of whether the vaporization device 100 is inserted in the charging box and the charging base in a forward direction or a backward direction, the adjustment circuit 24 may be configured to adjust a charging current, to complete charging of the vaporization device 100. For example, it is assumed that power is supplied to a first power input point P1 (not shown) and a second power input point P2 (not shown) of the charging circuit board 23 through the charging conductive component 19, a first circuit output point T1 of the charging circuit board 23 is a positive pole (+) output, and a second circuit output point T2 is a negative pole (−) output. In a first condition, when the power input point P1 receives a power input of positive pole power, and the second power input point P2 receives a power input of negative pole power, by adjusting a configuration of a switch circuit module of the adjustment circuit 24, the first circuit output point T1 (not shown) is a positive pole, and the second circuit output point T2 (not shown) is a negative pole. In a second condition, when the power input point P1 receives a power input of negative pole power, and the second power input point P2 receives a power input of positive pole power, by adjusting the configuration of a switch circuit module of the adjustment circuit 24, the first circuit output point T1 is adjusted to a positive pole, and the second circuit output point T2 is adjusted to a negative pole. Therefore, regardless of how the polarities of the first power input point P1 and the second power input point P2 changes, the first circuit output point T1 and the second circuit output point T2 always maintain fixed output polarities by adjusting the adjustment circuit 24, and supply power to a next-level circuit, for example, the power supply component 20 and/or the main circuit board 15.

In some embodiments, the inner wall of the e-liquid storage component shell 2 may include a plurality of ribs, which are disposed at intervals. The ribs may be extended and disposed in parallel along an axis direction. In some embodiments, the ribs may be disposed in a non-parallel manner. The ribs may strengthen the rigidity of the e-liquid storage component shell 2. The ribs may prevent the e-liquid storage component shell 2 from deforming because of an extrusion of an external force. The ribs may prevent e-liquid in the storage compartment 1c from overflowing because of an extrusion of an external force.

Back to FIG. 3A to FIG. 4F, the hollow tube 51, the liquid absorbing sleeve 52 and the heating core 53 of the heating component 5 are disposed in the vaporization chamber 40 inside the heating component top cap 4. The hollow tube 51 is disposed along an axis direction of the aerosol channel 100c. E-liquid in the storage compartment 1c may be absorbed by the heating component 5 through the liquid inlet hole 4h1. The e-liquid absorbed on the heating component 5 generates an aerosol in the vaporization chamber 40 after being heated by the heating core 53. The aerosol may be inhaled by the user through the aerosol channel 100c. In this embodiment, the first liquid absorbing component 3 may absorb a liquid condensed from the aerosol, to prevent the condensed liquid from flowing out from the mouthpiece hole 1h unpredictably.

In some embodiments, the heating core 53 may have a self-limiting temperature characteristic. A resistance value of the heating core 53 may increase as the temperature rises. When the temperature of the heating core 53 is reaches a threshold T1, a resistance value R1 is generated. In some embodiments, when the temperature of the heating core 53 reaches a threshold T1, even if the heating core 53 is connected to the body 100B, the temperature of the heating core 53 can be no longer raised. In some embodiments, when the resistance value of the heating core 53 reaches R1, heating power output by the heating core 53 can no longer raise the temperature of the heating core 53.

In some embodiments, the threshold T1 is in the range of 200° C. to 220° C. In some embodiments, the threshold T1 is in the range of 220° C. to 240° C. In some embodiments, the threshold T1 is in the range of 240° C. to 260° C. In some embodiments, the threshold T1 is in the range of 260° C. to 280° C. In some embodiments, the threshold T1 is in the range of 280° C. to 300° C. In some embodiments, the threshold T1 is in the range of 280° C. to 300° C. In some embodiments, the threshold T2 is in the range of 300° C. to 320° C.

In some embodiments, the heating core 53 has a resistance value greater than 10Ω when heated to the threshold T1. In some embodiments, the heating core 53 has a resistance value greater than 15Ω when heated to the threshold T1. In some embodiments, the heating core 53 has a resistance value greater than 20Ω when heated to the threshold T1. In some embodiments, the heating core 53 has a resistance value greater than 30Ω when heated to the threshold T1.

The self-limiting temperature characteristic of the heating core 53 may prevent the heating core 53 from dry burning. The self-limiting temperature characteristic of the heating core 53 may reduce a probability of burning the heating device 13. The self-limiting temperature characteristic of the heating core 53 may increase safety of the heating device 13. The self-limiting temperature characteristic of the heating core 53 may prolong service life of each component in the heating device 13. The self-limiting temperature characteristic of the heating core 53 may effectively reduce the risk of nicotine cracking.

The self-limiting temperature characteristic of the heating core 53 may control the smoke emission temperature of the vaporization device 100 at the mouthpiece hole 1h within a specific temperature, to avoid scalding the lips. In some embodiments, the smoke emission temperature of the vaporization device 100 may be controlled within the range of 35° C. to 60° C. In some embodiments, the smoke emission temperature of the vaporization device 100 may be controlled within the range of 35° C. to 40° C. In some embodiments, the smoke emission temperature of the vaporization device 100 may be controlled within the range of 40° C. to 45° C. In some embodiments, the smoke emission temperature of the vaporization device 100 may be controlled within the range of 45° C. to 50° C. In some embodiments, the smoke emission temperature of the vaporization device 100 may be controlled within the range of 50° C. to 55° C. In some embodiments, the smoke emission temperature of the vaporization device 100 may be controlled within the range of 55° C. to 60° C.

In some embodiments, the heating component 5 includes a protective component (not shown) connected to the heating core 53.

In some embodiments, the protective component has a recoverable characteristic.

When the temperature of the protective component rises to a threshold T2, the protective component forms an open circuit. When the temperature of the protective component drops to a threshold e, the protective component forms a short circuit. When the temperature of the protective component rises to a threshold T2, a current cannot be supplied to the heating core 53. When the temperature of the protective component drops to a threshold T3, the current may be supplied to the heating core 53.

In some embodiments, the threshold T3 may be the same as the threshold T2. In some embodiments, the threshold T3 may be different from the threshold T2. In some embodiments, the threshold T3 may be less than the threshold T2.

Referring to FIG. 3D, FIG. 4E, and FIG. 4F. Aside from the mouthpiece hole 1h, the aerosol channel 100c formed by the mouthpiece tube 1t, the first liquid absorbing component 3, and the connection tube 4t1 may have a smooth inner diameter. The inner diameter of an aerosol channel 100t does not have an obvious segment gap in a junction of the mouthpiece tube 1t and the first liquid absorbing component 3. There is no obvious segment gap in a junction of the first liquid absorbing component 3 and the connection tube 40. The inner diameter of the aerosol channel 100t does not have an obvious boundary in the joint of the mouthpiece tube 1t and the first liquid absorbing component 3. The inner diameter of the aerosol channel 100t does not have an obvious boundary in the junction of the first liquid absorbing component 3 and the connection tube 4t1.

In another embodiment that is not shown, the aerosol channel 100c formed by the mouthpiece tube 1t, the first liquid absorbing component 3, and the connection tube 4t1 may have uneven inner diameters. For example, an inner diameter of the mouthpiece tube 1t may be greater than an inner diameter of the first liquid absorbing component 3. The inner diameter of the first liquid absorbing component 3 may be greater than an inner diameter of the connection tube 4t1. An inner diameter of the mouthpiece tube 1t adjacent to the mouthpiece hole 1h may be greater than an inner diameter of the mouthpiece tube 1t adjacent to the first liquid absorbing component 3. The e-liquid storage component shell 2, the first liquid absorbing component 3, the heating component top cap 4, the heating component 5, the heating component base 6, and the e-liquid cup base 7.

In some embodiments, hardness of the heating component top cap 4 and the e-liquid cup base 7 may be greater than hardness of the heating component base 6. In this way, through an appropriate deformation of that the heating component base 6 is engaged to the heating component top cap 4 and the e-liquid cup base 7, a sealing degree of that the heating component base 6 is engaged to the heating component top cap 4 and the e-liquid cup base 7 may be improved, a tolerance requirement is lowered, and a manufacturing difficulty is reduced. In some embodiments, the hardness of the heating component top cap 4 may be less than hardness of the e-liquid storage component shell 2. In some embodiments, hardness of the sealing component 41 may be less than the hardness of the heating component top cap 4. The sealing component 41 may improve a sealing degree between the e-liquid storage component shell 2 and the heating component top cap 4. The sealing component 41 may lower a tolerance requirement of the e-liquid storage component shell 2 and the heating component top cap 4. The sealing component 41 may reduce a manufacturing difficulty of the e-liquid storage component shell 2 and the heating component top cap 4. The sealing component 41 may prevent the e-liquid storage component shell 2 and the heating component top cap 4 from being damaged in an component process. The sealing component 41 may further prevent e-liquid in the storage compartment 1c from being sucked out from the mouthpiece hole 1h.

Referring to FIG. 4E and FIG. 4F. When the user inhales from the mouthpiece hole 1h, an air flow is generated in the e-liquid storage component 100A. A front segment of the air flow G1 includes fresh air entering the vaporization chamber 40 from the air inlet holes 7h5 and 7h6 of the e-liquid cup base 7. A back segment of the air flow G1 includes an aerosol generated by the heating component 5. The fresh air enters the vaporization chamber 40 through the air inlet holes 7h5 and 7h6 and the flow guide groove 72, and the aerosol generated by the heating component 5 is discharged from the mouthpiece hole 1h along the aerosol channel 100c.

The air flow is heated by the heating component 5 in the vaporization chamber 40, so that a temperature changes, and a volatile material is is simultaneously vaporized into the air flow.

When the air flow flows to the connection tube 4t1, because the inner diameter of the connection tube 4t1 is less than the inner diameter of the vaporization chamber 40, the air flow starts to accelerate, and the temperature decreases. After the air flow enters the vaporization chamber 40, a temperature rise Tr is generated by heating the air flow by the heating component 5. In some embodiments, the temperature rise Tr may be within a range of 200° C. to 220° C. In some embodiments, the temperature rise Tr may be within a range of 240° C. to 260° C. In some embodiments, the temperature rise Tr may be within a range of 260° C. to 280° C. In some embodiments, the temperature rise Tr may be within a range of 280° C. to 300° C. In some embodiments, the temperature rise Tr may be within a range of 300° C. to 320° C. In some embodiments, the temperature rise Tr may be within a range of 200° C. to 320° C.

An airflow from the vaporization chamber 40 may generate a temperature drop Tf before reaching the mouthpiece hole 1h. In some embodiments, the temperature drop Tf may be within a range of 145° C. to 165° C. In some embodiments, the temperature drop Tf may be within a range of 165° C. to 185° C. In some embodiments, the temperature drop Tf may be within a range of 205° C. to 225° C. In some embodiments, the temperature drop Tf may be within a range of 225° C. to 245° C. In some embodiments, the temperature drop Tf may be within a range of 245° C. to 265° C. In some embodiments, the temperature drop Tf may be within a range of 145° C. to 265° C.

In some embodiments, the aerosol channel 100c may have an uneven inner diameter. The inner diameter of the aerosol channel 100t gradually increases from a position adjacent to the heating component 5 to a direction of the mouthpiece hole 1h. The relatively large inner diameter adjacent to the mouthpiece hole 1h may cause a volume of the aerosol to be enlarged.

By adjusting an inner wall width of the vaporization chamber 40 and an inner diameter width of the aerosol channel 100c, the temperature of the aerosol inhaled by the user from the mouthpiece hole 1h may be controlled. By adjusting the inner wall width of the vaporization chamber 40 and an inner diameter width of the aerosol channel 100t, a volume of the aerosol inhaled by the user from the mouthpiece hole 1h may be controlled.

Controlling the temperature of the aerosol may prevent the user from being scalded by the aerosol. Controlling the volume of the aerosol may improve an inhalation experience of the user.

In some embodiments, the aerosol inhaled by the user through the mouthpiece hole 1h can have a temperature below 65° C. In some embodiments, the aerosol inhaled by the user through the mouthpiece hole 1h can have a temperature below 55° C. In some embodiments, the aerosol inhaled by the user through the mouthpiece hole 1h can have a temperature below 50° C. In some embodiments, the aerosol inhaled by the user through the mouthpiece hole 1h can have a temperature below 45° C. In some embodiments, the aerosol inhaled by the user through the mouthpiece hole 1h can have a temperature below 40° C. In some embodiments, the aerosol inhaled by the user through the mouthpiece hole 1h can have a temperature below 30° C.

The main circuit board 15 and the charging circuit board 23 may further includes an output detection circuit, a temperature detection circuit, a charging detection circuit, a light-emitting component, a charging protection circuit, a charging management circuit, and a power supply component protection circuit. The foregoing circuit may respectively perform functions such as signal output, temperature detection, charging detection, light emitting, charging protection, charging management and power supply component protection.

In some embodiments, the vaporization device 100 may set a light-emitting mode of the light-emitting component 153 according to an inhalation action of the user and by combining the controller 151, the sensor 13, and the light-emitting component 153 on the main circuit board 15. In some embodiments, when detecting the inhalation action, the sensor 13 may transmit a sensing signal to the controller 151, and the controller 151 transmits a light-emitting start signal to the light-emitting component 153, and the light-emitting component 153 emits light based on the light-emitting start signal. In some embodiments, white light is emitted by a light-emitting diode (LED) of the light-emitting component 153. The light emitted by the light-emitting component 153 is visible through the light guide holder 14 and the light transmitting component 221.

In some embodiments, the light-emitting start signal is a signal with an intensity that changes with time, so that the light-emitting component 153 emits light with an intensity that changes with time. In some embodiments, the intensity of the light-emitting start signal gradually increases with time, and the intensity of the light emitted by the light-emitting component 153 gradually increases with time. In some embodiments, after the intensity of the light-emitting start signal gradually increases with time to a preset time, the light-emitting start signal maintains the intensity. In some embodiments, the preset time is within a range of 1 second to 3 seconds. In some embodiments, the preset time may be 2 seconds.

In some embodiments, after the sensor 13 detects the inhalation action, if the user stops the inhalation action, the sensor 13 stops transmitting the sensing signal. The controller 151 may generate the light-emitting start signal, the controller 151 transmits the light-emitting start signal to the light-emitting component 153, and the light-emitting component 153 emits light based on the light-emitting start signal. In some embodiments, white light is emitted by a light-emitting diode (LED) of the light-emitting component 153. The light emitted by the light-emitting component 153 is visible through the light guide holder 14 and the light transmitting component 221.

The vaporization device 100 may charge the power supply component 20 through an external signal transmitted by an external device. In some embodiments, the external signal may be received through the charging conductive component 19. The vaporization device may charge the power supply component 20 by using different charging currents, so that a charging time is effectively reduced, a life of the power supply component 20 is extended, and it is prevented that the power supply component 20 is overheated and injures the user.

In some embodiments, the charging current of the vaporization device 100 may be set to be performed in combination of the controller 151, the temperature detection circuit, the charging detection circuit, the charging protection circuit, the charging management circuit, the charging conductive component 19, the charging circuit board 23, the adjustment circuit 24 and the port 25.

According to an aspect of an embodiment of this application, a method for preparing the vaporization device includes: first mounting the first liquid absorbing component 3 inside the mouthpiece cap 1 and the e-liquid storage component shell 2; engaging the sealing component 41 to the annular stop groove 41g1; accommodating the heating component 5 in the heating component top cap 4, mounting the heating component top cap 4, the heating component base 6 and the e-liquid cup base 7 with each other, and mounting the three at the mouthpiece cap 1 and the e-liquid storage component shell 2 together; injecting a volatile material (for example, e-liquid) into the storage compartment 1c through the third electrically conductive channels 7h1 and 7h2, and fixing the columnar electrically conductive structures 7p1 and 7p2 to the third electrically conductive channels 7h1 and 7h2, to seal the storage compartment 1c. In this way, the e-liquid storage component 100A is assembled.

As shown in FIG. 2A and FIG. 2B, the body 100B is prepared by sequentially assembling the electrically conductive component 11, the magnetic is component 12, the sensor 13, the sealing kit 13a, the light guide holder 14, the main circuit board 15, the vibrator 17, the magnetically conductive components 18a and 18b, the charging conductive component 19, the power supply component 20, the power supply component holder 21, the charging circuit board 23, the adjustment circuit 24, and the port 25 into the body shell 22; then the vaporization device 100 is prepared by mounting the e-liquid storage component 100A on the body 100B from the opening 22h. According to the preparation of the vaporization device 100 of the present application, the process of assembling is simplified, and manufacturing costs and man-hours are effectively reduced.

In some embodiments, the e-liquid storage component 100A may be easily replaced. That is, when the vaporizable material in the e-liquid storage component 100A is used up, another new e-liquid storage component 100A may be used for replacement. In this way, the original body 100B may be continued to be used, which saves resources. In addition, this helps the user to user different e-liquid storage components 100A, to reduce purchase costs.

As used herein, the terms “approximately”, “basically”, “substantially”, and “about” are used to describe and consider small variations. When used in combination with an event or a situation, the terms may refer to an example in which an event or a situation occurs accurately and an example in which the event or situation occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all ranges disclosed herein include endpoints. The term “substantially coplanar” may refer to two surfaces within a few micrometers (lam) positioned along the same plane, for example, within 10 lam, within 5 μm, within 1 μm, or within 0.5 μm located along the same plane. When reference is made to “substantially” the same numerical value or characteristic, the term may is refer to a value within ±10%, ±5%, ±1%, or ±0.5% of the average of the values.

As used herein, the terms “approximately”, “basically”, “substantially”, and “about” are used to describe and explain small variations. When used in combination with an event or a situation, the terms may refer to an example in which an event or a situation occurs accurately and an example in which the event or situation occurs approximately. For example, when being used in combination with a value, the term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, if a difference between two values is less than or equal to ±10% of an average value of the value (for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), it could be considered that the two values are “substantially” the same. For example, being “substantially” parallel may refer to an angular variation range of less than or equal to ±10° with respect to 0°, for example, less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°. For example, being “substantially” perpendicular may refer to an angular variation range of less than or equal to ±10° with respect to 90°, for example, less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

For example, two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be planar or substantially planar if a difference between any two points on the surface is no greater than 5 μm, no greater than 2 μm, no greater than 1 μm, or no greater than 0.5 μm.

As used herein, the terms “conductive”, “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

As used herein, singular terms “a”, “an”, and “said” may include plural referents unless the context clearly dictates otherwise. In the description of some embodiments, components provided “on” or “above” another component may encompass a case in which a previous component is directly on a latter component (for example, in physical contact with the latter component), and a case in which one or more intermediate components are located between the previous component and the latter component.

As used herein, for ease of description, space-related terms such as “under”, “below”, “lower portion”, “above”, “upper portion”, “lower portion”, “left side”, “right side”, and the like may be used herein to describe a relationship between one component or feature and another component or feature as shown in the figures. In addition to orientation shown in the figures, space-related terms are intended to encompass different orientations of the device in use or operation. An apparatus may be oriented in other ways (rotated 90 degrees or at other orientations), and the space-related descriptors used herein may also be used for explanation accordingly. It should be understood that when a component is “connected” or “coupled” to another component, the component may be directly connected to or coupled to another component, or an intermediate component may exist.

Several embodiments of the present invention and features of details are briefly described above. The embodiments described in the present invention may be easily used as a basis for designing or modifying other processes and structures for realizing the same or similar objectives and/or obtaining the same or similar advantages introduced in the embodiments of the present invention. Such equivalent construction does not depart from the spirit and scope of the present invention, and various variations, replacements, and modifications can be made without departing from the spirit and scope of the present invention.

What is claimed is:

1. A vaporization device, comprising:
an e-liquid storage component, comprising an electrical coupling point; and
a body, electrically coupled to the e-liquid storage component, wherein the body comprises:
a body shell, comprising a cavity;
a power supply component holder, disposed in the cavity, wherein the power supply component holder comprises a first end and a second end opposite to each other;
a power supply component, disposed on the power supply component holder;
a charging conductive component, disposed at the second end of the power supply component holder; and
is a magnetically conductive component, disposed at the second end of the power supply component holder.

2. The vaporization device according to claim 1, wherein the e-liquid storage component comprises the electrical coupling point, the body further comprises an electrically conductive component, and the electrically conductive component is disposed at the first end of the power supply component holder, and is configured to be electrically coupled to the electrical coupling point.

3. The vaporization device according to claim 2, wherein the body further comprises:
a magnetic component, disposed on the electrically conductive component.

4. The vaporization device according to claim 3, wherein the power supply component holder has electrically conductive grooves and an empty groove, the empty groove is located between the electrically conductive grooves, and the electrically conductive component is disposed in the electrically conductive grooves.

5. The vaporization device according to claim 4, wherein the e-liquid storage component has an air inlet hole, and the body further includes:
a liquid absorbing component, disposed in the empty groove, wherein the empty groove and the liquid absorbing component face the air inlet hole.

6. The vaporization device according to claim 1, wherein the power supply component holder comprises a sensor installation groove, and the body further comprises:
a sensor, disposed in the sensor installation groove; and
a main circuit board, fixedly disposed at the sensor.

7. The vaporization device according to claim 6, wherein the first end of is the power supply component holder comprises an air flow channel in communication with the sensor installation groove.

8. The vaporization device according to claim 6, wherein the body comprises:
a sealing kit, disposed between the sensor and the sensor installation groove.

9. The vaporization device according to claim 1, wherein the body comprises:
a main circuit board, disposed at the power supply component holder; and
a charging circuit board, disposed at the power supply component holder, wherein the charging circuit board is electrically coupled to the main circuit board and the charging conductive component.

10. The vaporization device according to claim 9, wherein the power supply component is located between the charging circuit board and the main circuit board.

11. The vaporization device according to claim 1, wherein the charging circuit board comprises:
an adjustment circuit, configured to switch a current from the charging conductive component, so that a first output point of the charging circuit board is always a positive pole, and a second output point of the charging circuit board is always a negative pole.

12. The vaporization device according to claim 1, wherein a quantity of the magnetically conductive components and a quantity of magnets in the charging conductive components are two, and polarities of the two magnetically conductive components facing away from the e-liquid storage component are the same.

13. The vaporization device according to claim 1, wherein a quantity of the magnetically conductive components and a quantity of magnets in the charging conductive components are two, and polarities of the two magnetically conductive components facing away from the e-liquid storage component are opposite to each other.

14. The vaporization device according to claim 1, wherein a quantity of the magnetically conductive components and a quantity of the charging conductive components are two, and the body further comprises:
a port, disposed at the second end of the power supply component holder, wherein the ports is located between the charging conductive components.

15. The vaporization device according to claim 14, wherein the port is a universal serial bus (USB) port, and the charging conductive component is a pogo pin.

16. The vaporization device according to claim 14, wherein the second end of the body shell has a first opening exposing the port, an outer side of the first opening is a camber surface, and an inner side of the first opening is a planar surface.

17. The vaporization device according to claim 1, wherein an inner wall surface of the body shell comprises an engaging portion, the first end of the power supply component holder may comprise an elastic engaging component, and the engaging portion is mechanically coupled to the elastic engaging component.

18. A vaporization device, comprising:
an e-liquid storage component, comprising a first electrical coupling point and a second electrical coupling point; and
a body, electrically coupled to the first electrical coupling point and the second electrical coupling point, wherein the body comprises:
is a body shell, comprising a cavity;
a power supply component holder, disposed in the cavity, wherein the power supply component holder comprises a first end and a second end opposite to each other;
an electrically conductive component, disposed at the first end of the power supply component holder, and configured to be electrically coupled to the first electrical coupling point;
two charging conductive components, disposed at the second end of the power supply component holder; and
a port, located at the second end, wherein the port is located between the two charging conductive components.

19. The vaporization device according to claim 18, wherein the port is a USB port, and the charging conductive components are pogo pins.

20. The vaporization device according to claim 18, wherein the body further comprises:
a magnetic component, disposed on the electrically conductive component.
